(19) United States
(12) Patent Application Publication
(10) Pub. No.: US 2026/0030567 A1
(43) Pub. Date: Jan. 29, 2026

(54) GENERATING CANDIDATE SUBTASKS FOR A TASK CREATED BY A USER THROUGH A GENERATIVE MODEL AND SUPPLEMENTAL TASKS PREVIOUSLY CREATED BY THE USER

(71) Applicant: Mango Technologies, Inc. DBA ClickUp, San Diego, CA (US)

(72) Inventors: Hariharan Rajagopalan, Mountain View, CA (US); Yuxiang Kou, Mountain View, CA (US); Erich Elendt, Toronto (CA)

(21) Appl. No.: 18/780,671

(22) Filed: Jul. 23, 2024

(51) Int. Cl. G06Q 10/0631

(52) U.S. Cl. CPC G06Q 10/06311

(57) ABSTRACT

A task management system stores different types of content items, such as tasks, data objects, or interactions with tasks. Some tasks may be decomposed into subtasks that each correspond to a sub-action to complete so the action corresponding to a task can be completed. To more efficiently generate subtasks associated with a task, the task management system selects a set of supplemental tasks that were previously created by the user from whom the task was received. For example, the set of supplemental tasks includes tasks created by the user and in a common list as the task. Based on the task and the set of supplemental tasks, the task management system generates a prompt for a generative model. The generative model generates one or more subtasks for the task based on the set of supplemental tasks and information about the task.

### BACKGROUND

In many collaborative environments, such as product development, multiple users perform various actions to complete a project. Often, different users perform different actions, and the completed actions of different users are combined to create the product. To monitor the progress of actions performed by different users, a user may generate one or more tasks stored in a computer system. A task corresponds to an action and has an assigned performing user, who performs the action corresponding to the task. Performing users interact with a task to modify one or more attributes of the task. Modifications to one or more attributes of the task because of an interaction provide information about performance of the task. For example, an attribute of a task identifies a status of the task or an amount of the action corresponding to the task that has been completed by a performing user.

To simplify performance of a task, a user may decompose the task into multiple subtasks, with each subtask corresponding to one or more sub-actions that comprise different portions of the task. The user creating a task may assign different subtasks to different performing users so different portions of the task may be completed in parallel or by different performing users. Further, decomposing a task into subtasks allows the user to identify discrete sub-actions to perform to complete the action corresponding to the task, allowing for more systematic completion of the task by identifying each sub-action to be performed.

However, decomposing a task into constituent subtasks is time-intensive for a user, and involves frequent interaction with a computer system maintaining a task. Such frequent interaction increases computational resources used by the computer system. Additionally, manually creating subtasks may cause inconsistencies in subtasks created across multiple tasks, increasing an amount of time for certain tasks to be completed and increasing difficulty inf allocating subtasks to performing users across different tasks. Similarly, manually creating subtasks for a task may result in varying complexities of performing different subtasks or varying amounts of sub-actions involved for completing different subtasks, increasing an amount of time to fully complete all subtasks associated with a task.

### SUMMARY

In accordance with one or more aspects of the disclosure, a task management system receives a task from a user and stores the task in association with one or more attributes and with the user. The task corresponds to an action to be performed, and the task management system receives an identifier of a performing user to perform the task from the user and stores an identifier of the performing user in association with the task. One or more attributes associated with the task identify a status of the action corresponding to the task by the performing user. The task management system receives a name of the task and a description of the task that the task management system stores in association with a task identifier of the task. In various embodiments, the name of the task comprises unstructured text received from the user via an interface generated by the task management system. Similarly, in various embodiments, the description of the task comprises unstructured text the task management system receives from the user through the interface, or through another interface.

One or more tasks received from the user may be complex, involving multiple sub-actions to complete. A complex task may be decomposed into multiple subtasks, with each subtask corresponding to a sub-action to perform in furtherance of completing the action associated with the task. Further, different performing users may be assigned to different sub-tasks to further aid in completing the action corresponding to the task. In conventional task management systems, the user manually identifies and describes different subtasks associated with a task. Manually identifying subtasks for a task is often time consuming and requires significant user interaction with the task management system to identify and to refine subtasks associated with a task.

To more efficiently decompose a task into subtasks, the task management system selects a set of supplemental tasks associated with the task. Each supplemental task has one or more specific attributes. For example, each supplemental task was previously created by the user. In various embodiments, the task management system maintains a hierarchy of tasks, where a list is associated with one or more tasks. Each task in a list has one or more common attributes in various embodiments. The task management system leverages the hierarchy of tasks to select the set of supplemental tasks in various embodiments. For example, the task management system selects tasks that were previously created by the user and that are associated with a list that is associated with the task.

The task management system may use other attributes of tasks created by, or otherwise associated with, the user to select the set of supplemental tasks, in various embodiments. For example, the task management system accounts for times when tasks were created when selecting the set of supplemental tasks. As an example, the task management system selects tasks created by the user, associated with a list associated with the task, and created within a threshold amount of time from a time when the task management system received the task from the user. In another example, the task management system identifies additional tasks associated with the list associated with the task and that were created by the user. The task management system generates a ranking of the additional tasks based on times when the additional tasks were created relative to a time when the task management system received the task. Additional tasks more recently created by the user have higher positions in the ranking than additional tasks less recently created by the user. The task management system selects additional tasks having at least a threshold position in the ranking as the set of supplemental tasks. This biases selection of supplemental tasks to tasks that were more recently created by the user.

Based on the task and the set of supplemental tasks, the task management system generates a prompt for a generative model, such as a large language model (LLM). The prompt includes the title and the description of the task, titles and descriptions of each supplemental task of the set, and an instruction to generate one or more subtasks for the task based on the title and the description of the task. In various embodiments, the prompt includes descriptive information of one or more subtasks associated with one or more supplemental tasks of the set. For example, a supplemental task of the set is associated with one or more subtasks, so the prompt includes descriptive information of each of the subtasks (e.g., a title of a subtask) associated with the supplemental example. Including the set of supplemental examples in the prompt provides the generative model with examples of an expected output, allowing the generative model to account for grammatical, stylistic, or other preferences of the user when generating output. This allows the generative model to leverage information about prior task generation by the user through the set of supplemental examples to generate output that more accurately reflects how the user would be likely to create subtasks. Additionally, the task management system includes one or more comments about a supplemental task stored by the task management system in the prompt in conjunction with the supplemental task or includes one or more comments about the task stored by the task management system in various embodiments.

Based on the prompt and previously learned relationships between portions of text during a pre-training process, the generative model generates one or more candidate subtasks associated with the task. The task management system presents the candidate subtasks to the user through an interface or through another communication channel. For example, the task management system displays a title of each candidate subtask to the user in a portion of an interface. Subsequently, the user may select one or more of the candidate subtasks to associate with the task. The task management system stores the selected candidate subtasks in association with the task, but does not store candidate subtasks that are not selected in association with the task. The user may modify a candidate subtask through one or more interactions with the task management system, which stores the modified candidate subtask in response to receiving a specific selection or input from the user. For example, the user adds or modifies one or more words comprising a title of a candidate subtask and provides an input to the task management system to store the modified candidate subtask in association with the task.

Leveraging the generative model and the set of supplemental tasks streamlines generation of subtasks that are associated with the task. Automatically presenting the candidate subtasks generated by the generative model reduces an amount of time spent by the user decomposing the task into different subtasks, while increasing standardization of form and content of subtasks by using the set of supplemental tasks to account for prior creation of tasks or subtasks by the user. This allows the task management system to more efficiently decompose a task into constituent subtasks, which reduces overall user interaction with the task management system.

### BRIEF DESCRIPTION OF THE DRAWINGS

FIG. 1 illustrates an example system environment for a task management system, in accordance with one or more embodiments.

FIG. 2 illustrates an example system architecture for a task management system, in accordance with one or more embodiments.

FIG. 3 illustrates an example flowchart of a method for generating one or more subtasks for a task received from a user using a generative model and supplemental tasks previously created by the user, in accordance with one or more embodiments.

FIG. 4 illustrates a process flow diagram of a method for generating one or more subtasks for a task received from a user using a generative model and supplemental tasks previously created by the user, in accordance with one or more embodiments.

### DETAILED DESCRIPTION

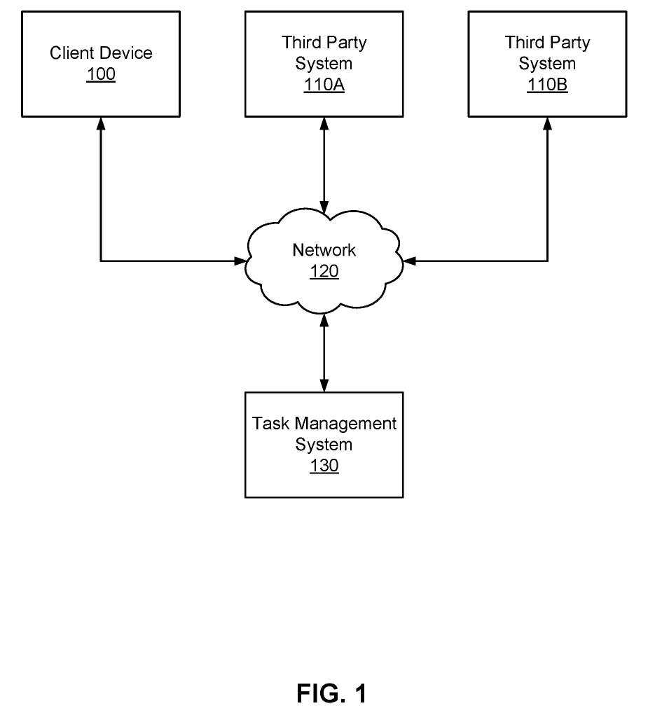

FIG. 1 illustrates an example system environment for a task management system 130, in accordance with one or more embodiments. The system environment illustrated in FIG. 1 includes a customer client device 100, one or more third party systems 110A, 110B (also referred to individually and collectively using reference number 110), a network 120, and a task management system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

While FIG. 1 shows a single client device 110 for purposes of illustration, any number of client devices 100 may be included in the system environment. As such, there may be more than one client device 100 in various embodiments. The client device 100 is a device through which a user may interact with one or more third party systems 110 or with the task management system 130. The client device 100 can be a personal or mobile computing device, such as a smartphone, a tablet, a laptop computer, or desktop computer. In some embodiments, the customer client device 100 executes a task management application that uses an application programming interface (API) to communicate with the task management system 130.

Through interaction with the client device 100, a user creates one or more tasks stored by the task management system 130 via the task management application, with each task corresponding to one or more actions to be performed and a performing user to perform the one or more actions. The performing user may be the user who created the task or may be a different user. Additionally, the user may specify one or more attributes of a task. Example attributes of a task include a status of the task, a due date for the task, a priority level of the task, a resource allocation (e.g., a budget) for performing the task, one or more comments about the task, or other information relevant to performing an action corresponding to the task.

In various embodiments, the task management application executing on the client device 100 presents a workflow management interface to the user. The workflow management interface is a user interface that receives input from the user to identify or create tasks, generate a list of related tasks, generate a hierarchy of tasks, associate a task with a performing user, modify one or more attributes of a task, or perform other interactions affecting one or more tasks. In various embodiments, the workflow management interface allows the user to search for tasks satisfying one or more attributes that are identified by task management system 130 and accessible to the user. Additionally, the workflow management interface includes one or more messaging elements allowing the user to provide messages for transmission to one or more receiving users of the task management system 130.

The client device 100 may receive additional content from the task management system 130 to present to a customer. For example, the client device 100 may receive one or more messages for presentation to the user. As another example, the client device receives notifications from the task management system 130 and presents the notifications to the customer. A notification may indicate a change to an attribute of a task associated with the user (e.g., a change in a status of the task).

In some embodiments, the task management application also generates and presents a communication interface to the user that allows the customer to communicate messages to the task management system 130, to a receiving user of the task management system 130, or to a third party system 110. A message may include text data, audio data, image data, video data, or any combination thereof. For example, a message is a text message or a chat message. The client device 100 transmits a message via the network 120 and may receive one or more message via the network 120. In some embodiments, the communication interface may allow the user of the client device 100 and another user to communicate through audio or video communications, such as a phone call, a voice-over-Internet-Protocol call, or a video call.

A third party system 110 is a computing system separate from the task management system 130 that interacts with the task management system 130 or with the client device 100. In various embodiments, different third party systems 110A, 110B provide different types of content to the task management system 130 or to the client device 100. For example, a third party system 110 is an application provider communicating information describing one or more applications for execution by a client device 100 or communicating data to a client device 100 for use by an application executing on the client device 100. In other embodiments, a third party system 110 provides content or other information for presentation via a client device 110. A third party system 110 may also communicate information to the task management system 130, such as files, documents, metadata, or other information to the task management system 130.

The customer client device 100, the one or more third party systems 110, and the task management system 130 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include BLUETOOTH® or near-field communication (NFC) technologies or protocols for local communications between computing devices. The network 120 may transmit encrypted or unencrypted data.

The task management system 130 is an online system by which users identify tasks specifying actions to be performed, identify a performing user to perform an action identified by a task, and specify attributes of the task. The task management system 130 maintains associations between users and tasks. For example, the task management system 130 stores an association between a task identifier of a task and one or more user identifiers of users, such as a user who identified the task and one or more performing users associated with the task. The task management system 130 receives modifications to one or more attributes of a task from a user associated with the task, and updates the attributes of the task based on the received modifications. Additionally or alternatively, the task management system 130 may modify one or more attributes of a task based on information describing actions performed by a user. The task management system 130 transmits a notification to a client device 100 of a user associated with a task in response to an attribute of the task being modified, allowing a user associated with the task to remain informed of changes to one or more attributes of the task.

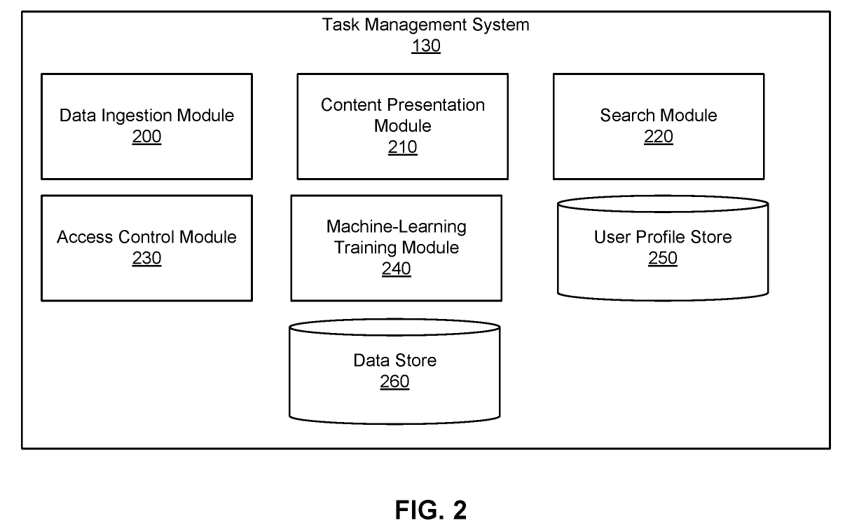

Additionally, the task management system 130 may generate one or more interfaces for a user associated with one or more tasks. For example, an interface identifies tasks associated with a user and identifies at least a set of attributes of the tasks, allowing the user to readily review and identify attributes of different tasks. The interface may identify relationships between tasks or between tasks and one or more subtasks of a task identified by a user, allowing a user to visualize relationships between different tasks. Further, the task management system 130 may store files or other data associated with a task or store information from retrieving files or data associated with the task from a third party system 110 to simplify access to data for reviewing or for performing a task for a user. The task management system 130 is described in further detail below with regard to FIG. 2.

FIG. 2 illustrates an example system architecture for a task management system 130, in accordance with some embodiments. The system architecture illustrated in FIG. 2 includes a data ingestion module 200, a content presentation module 210, a search module 220, an access control module 230, a machine learning training module 240, a user profile store 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data ingestion module 200 collects data used by the task management system 130 and stores the data in the user profile store. For example, the data ingestion module 200 receives information from a user creating a task, including one or more attributes of a task, or instructions for modifying one or more attributes of a task. Additionally, the data ingestion module 200 receives information from a user including characteristics of a user for inclusion in a corresponding user profile. The data ingestion module 200 may encrypt some or all of the obtained data, such as certain data describing a user.

The data ingestion module 200 also receives data describing relationships between tasks. For example, a user may identify one or more discrete subtasks that correspond to different portions of a task. Further, the data ingestion module 200 may receive data describing a hierarchy of tasks. For example, the data ingestion module 200 receives an identifier of a list from a user along with identifiers of one or more tasks to associate with the list. Hence, the list includes one or more tasks, allowing a user to organize related tasks, tasks related to a common objective, or tasks having one or more other common criteria. Additionally hierarchical information may be specified in some embodiments. For example, the data ingestion module 200 receives an identifier of a category and identifiers of one or more lists associated with the category, allowing a user to generate a grouping of lists, and the tasks included in the lists. As further described below, the data ingestion module 200 stores information describing relationships between tasks in the data store 260.

Additionally, the data ingestion module 200 captures interactions by users with tasks and stores the interactions in an interaction log included in the data store 260. In various embodiments, when a user interacts with a task through the task management system 130, the data ingestion module 200 determines an identifier of the user, an identifier of the task with which the user interacted, a time when the interaction occurred, and a description of the interaction by the user with the task. When the interaction with a task modifies an attribute of the task, the description of the interaction by the user includes an identifier of the attribute of the modifier of the task and a modified value of the task. In some embodiments, the description of the interaction includes an indication that the interaction changed at least one attribute of the task. Capturing interactions by users with tasks allows the data ingestion module 200 to generate an interaction log in the data store 260 that may be used to subsequently identify modifications to attributes of a task or a history of how one or more users interacted with a task. This may be leveraged to generate a record of how one or more users interacted with one or more tasks over time.

The content presentation module 210 selects content for presentation to a user and generates one or more interfaces for displaying the content to the user. In various embodiments, the content presentation module 210 receives a request for content from the user including one or more criteria, selects one or more tasks having attributes satisfying one or more of the criteria, and generates an interface displaying information about the selected one or more tasks to a user. The content presentation module 210 generates instructions for transmission to a client device 100, which executes the instructions to generate an interface presenting the information about the selected one or more tasks. In various embodiments, the request from the user includes display instructions specifying how an interface presents information about the selected one or more tasks. For example, a request specifies a calendar view, so the content presentation module 210 generates an interface displaying information about one or more tasks on a calendar, with the calendar displaying information identifying a task, and one or more attributes of the task, in a portion of the calendar corresponding to a date associated with the task. As another example, a request includes a specific attribute of a task, and the content presentation module 210 selects tasks having the specific attribute and generates instructions for an interface presenting the selected tasks.

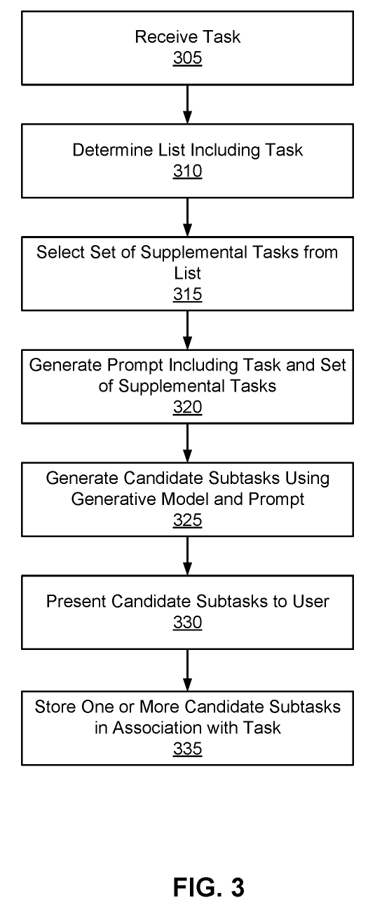

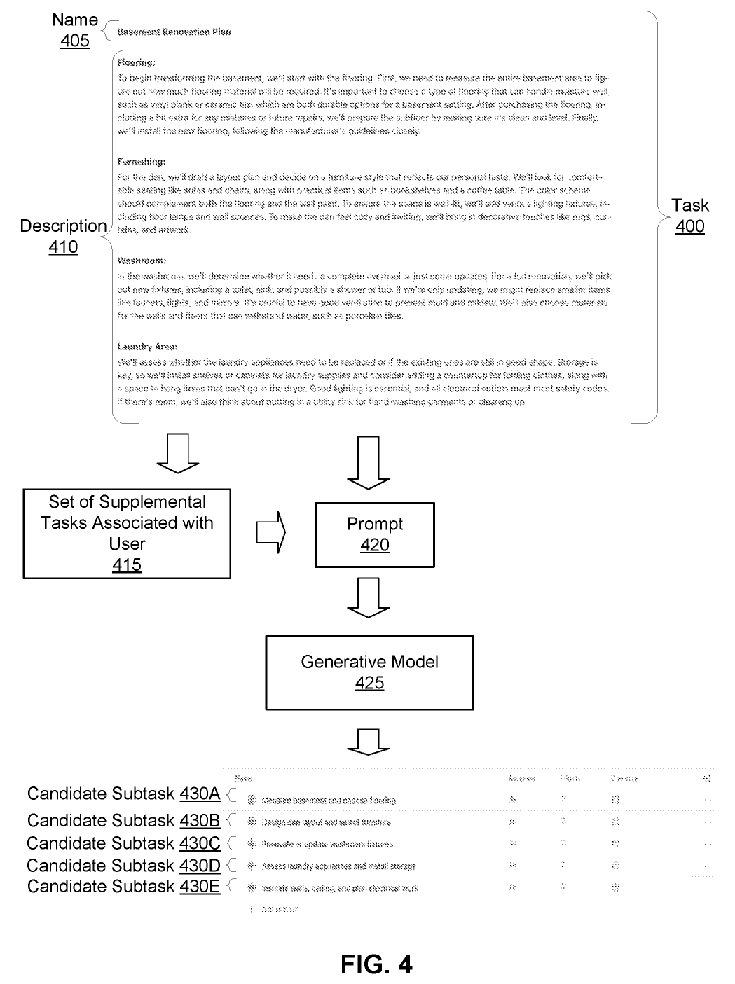

In various embodiments, the content presentation module 210 simplifies generation of one or more subtasks for a task created by a user by leveraging one or more generative models. As further described below in conjunction with FIGS. 3 and 4, for the task created by the user, the content presentation module 210 selects a set of supplemental tasks comprising tasks previously created by the user. Based on the task and the set of supplemental tasks, the data ingestion module generates a prompt for a generative model including the task and each of the set of supplemental tasks. For example, the prompt includes text describing the task received from the user, as well as text describing each supplemental task of the set. The content presentation module 210 applies a generative model, such as a large language model (LLM) to the prompt, and the generative model generates one or more candidate subtasks for the task based on the task and the supplemental tasks, as well as relationships between portions of text that the generative model previously learned during a pre-training process. Subsequently, the content presentation module 210 presents the candidate subtasks to the user, who may modify one or more of the candidate subtasks and select one or more of the candidate subtasks to store in association with the task, as further described below in conjunction with FIGS. 3 and 4.

The search module 220 receives a search query from the client device 100 and retrieves search results comprising tasks, or other data object, with attributes at least partially satisfying the search query. Data objects may be documents, video files, audio files, or other files accessible to the search module 200. A search query is text for a word or set of words that indicate attributes of a task or another data object. In various embodiments, the search model 220 generates a score for each task, or other data object, at least partially satisfying the search query and presents the search results based on their corresponding scores. For example, the search module 220 scores tasks or other data objects based on a measure of relevance of a task or a data object to a search query. For example, the search module 220 applies natural language processing (NLP) techniques to text in the search query to generate a search query embedding representing characteristics of the search query. The search module 220 may use the search query embedding to score candidate items for presentation to a customer (e.g., by comparing a search query embedding to an item embedding).

In some embodiments, a user authorizes the task management system 130 to access information associated with the user and stored by a third party system 110. In various embodiments, the search module 220 stores authentication information for the third party system 110 corresponding to the user in association with an identifier of the user and an identifier of the third party system 110. The authentication information for the third party system 110 may be a combination of a username and password or other authentication information for the user to access the third party system 110. In various embodiments, when the task management system 130 receives a search query from the user, the task management system, through one or more application programming interfaces (APIs), the search module 220 transmits the search query to the third party system 110 and retrieves files or other content items from the third party system 110 that at least partially satisfy the search query. This allows the search module 220 to evaluate both locally stored data in the data store 260 and data maintained by a third party system 110 for the user for search results, allowing the search module 220 to provide search results accounting for data associated with the user from one or more third party systems 130 that the user authorized the task management system 130 to access.

The access control module 230 regulates access to tasks by various users. When a user accesses the task management system 130, the access control module 230 retrieves a user profile of the user from the user profile store 250. Based on one or more permissions in the user profile, the access control module 230 identifies a subset of tasks from the data store 260 for the user based on the one or more permissions. For example, the access control module 230 identifies a subset of tasks that one or more permissions of the user authorize the user to access. Tasks in the subset may be presented to the user or be otherwise accessible to the user, while tasks in the data store 260 and not in the subset are inaccessible to the user. Hence, the access control module 230 to regulate access to stored tasks for different users,

Similarly, for a task, the access control module 230 determines a set of interactions a user is authorized to perform with the task based on one or more permissions in the user profile of the user. For example, a user with a first type of permission is authorized to modify one or more attributes of a task, while another user with a different type of permission is authorized to view the attributes of the task but is unable to modify one or more attributes of the task. As another example, one or more permissions of the user authorize the user to modify a set of attributes of the task, while preventing the user from modifying attributes that are not included in the set. The access control module 230 may receive permissions or modifications to permissions of a user from the user or from another user and store the permissions or the modified permissions in a user profile corresponding to the user. This allows the access control module 230 to regulate types of interactions with a task based on permissions of a user, enabling different users to perform different types of interactions with different tasks.

The machine learning training module 240 trains machine learning models used by the task management system 130. The task management system 130 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 240 updates the set of parameters for the machine learning model based on the score generated by the loss function. For example, the machine learning training module 240 may apply gradient descent to update the set of parameters.

In various embodiments, the machine learning training module 240 tunes one or more generative models that receive a text prompt and generate content based on the text prompt. A generative model is a large language model (LLM), such as a generative pre-trained transformer model (GPT) in various embodiments. The generative model may generate text in response to a text prompt in various embodiments. Alternatively or additionally, the generative model selects or generates an image in response to a text prompt. A generative model is model pre-trained on a text corpus including text to output text in response to a text prompt from a user. As another example, a generative model is a generative image model pre-rained on a corpus of images to output an image in response to a received text prompt. Obtaining a pre-trained generative model allows the machine learning training module 240 to leverage relationships between different text (or images) the generative model learned through application to a text corpus or image corpus including a larger amount of data and more varied data than the task management system 130 maintains. In various embodiments, a generative model configured to receive text as input and to generate text output learns relationships between different portions of text (e.g., words, phrases) during a pre-training process where the generative model is applied to a large text corpus; subsequently, the relationships between portions of text learned during pre-training enable generation of output text by the generative model in response to input text.

In various embodiments, the machine learning training model 240 generates examples for inclusion in a prompt input to a generative model. An example includes an input to the generative model and an expected output in response to the input. For example, an example includes input text and output text along with formatting instructions for the output text. When applying a generative model to input, the task management system 130 (e.g., the content presentation module 210) generates a prompt for the generative model that includes the input and one or more examples generated by the machine learning training model 240. This allows the example included in the prompt to specify a format or content of the output of the generative model based on the input. In some embodiments, the machine learning training model 240 generates a GPT index including embeddings corresponding to example to facilitate identification and retrieval of one or more supplemental examples based on an embedding of an input to a generative model. The machine learning training model 230 stores the GPT index including the supplemental examples, or the embeddings for the supplemental examples in various embodiments.

The user profile store 250 includes a user profile corresponding to each user of the task management system 130. A user profile of a user includes a user identifier of a corresponding user, characteristics of the user, contact information for the user, or other descriptive information about the user. In various embodiments, the user profile of the user includes task identifiers of tasks associated with the user. Further, in some embodiments, the user profile of the user includes one or more permissions of the user. One or more permissions included in the user profile of a user identify types of interactions the user is permitted to perform with one or more tasks. Different permissions may correspond to different tasks, allowing the user to perform different types of interactions with different tasks. A user profile may also maintain references to interactions by the corresponding user performed on one or more tasks and stored in an interaction log in the data store 260. This allows the user to review or to identify one or more interactions the user previously performed with tasks.

The data store 260 stores data used by the task management system 130. For example, the data store 260 stores tasks created by a user. In various embodiments, the data store 260 includes a task log that includes a task identifier for each task with corresponding attributes of a task associated with the task identifier. For example, the task log includes a task identifier for a task with attributes of the task associated with the task identifier. As further described above, example attributes of the task include: an identifier of a user to perform the task, a status of the task, a due date for the task, a priority level of the task, a resource allocation (e.g., a budget) for performing the task, one or more comments about the task, or other information relevant to performing an action corresponding to the task.

Additionally, the data store 260 stores an interaction log describing interactions by users with the task management system 130. The interaction log includes entries including a task identifier, a user identifier of a user who performed an interaction, a time when the interaction was performed, and a description of the interaction. The description of the interaction may be a type of the interaction and may include data received through the interaction. For example, an interaction is a comment on a task, and a description of the interaction includes a type indicating a comment and text data comprising the comment. In various embodiments, the interaction log organizes entries chronologically, while in other embodiments, the interaction log may organize entries using other formats.

The data store 260 also stores trained machine learning models trained by the machine learning training module 240. For example, the data store 260 may store the set of parameters for a trained machine learning model on one or more non-transitory, computer-readable media. As another example, the data store 260 stores parameters comprising a previously trained model that the machine learning training model 240 obtained from a third party 110 or from another source. For example, the data store 260 includes a generative model, such as a large language model (LLM) that the machine learning training module 240 obtained from a third party system 110. The data store 260 may also include one or more examples that a machine learning model, such as a generative model receives as input. The data store 260 uses computer-readable media to store data, and may use databases to organize the stored data.

FIG. 3 is a flowchart of a method for generating one or more subtasks for a task received from a user using a generative model and supplemental tasks previously created by the user, in accordance with one or more embodiments, in accordance with some embodiments. Alternative embodiments may include more, fewer, or different steps from those illustrated in FIG. 3, and the steps may be performed in a different order from that illustrated in FIG. 3. These steps may be performed by the task management system 130, or by another online system, in various embodiments. Additionally, each of these steps may be performed automatically by the task management system 130 without human intervention.

The task management system 130 stores tasks received from users or associated with users. A task specifies one or more actions to be performed and identifies a performing user to perform the one or more actions specified by the task. Additionally, a task has one or more attributes, which may be specified by a user who created the task or determined by the task management system 130. The task management system 130 maintains associations between users and tasks. For example, the task management system 130 stores an association between a task identifier of a task and one or more user identifiers of users, such as an identifier of a user who created the task and identifiers of one or more performing users associated with the task.

A task may be decomposed into multiple subtasks. Each subtask corresponds to a portion of the task and includes one or more sub-actions to perform for completing the portion of the task. A user associated with the task, such as a user who created the task, may assign different subtasks to different performing users, allowing different portions of the task to be completed in parallel or to be completed different performing users. Conventionally, a user associated with a task, such as the user who created the task, manually defines subtasks comprising a task. Such manual definition of subtasks for a task increases an amount of time spent by users identifying subtasks and results in variations in complexity and information included in different subtasks.

To simplify creation of subtasks for a task, the task management system 130 receives 305 a task from a user. For example, the task management system 130 receives a name of the task and a description of the task, and may receive one or more attributes of the task from the user via a creation interface or other interface. The name of the task and the description of the task are received 305 as text from the user. In various embodiments, the name of the task and the description of the task comprise unstructured text received 305 from the user. The task is created when the task management system 130 has received the name of the task in some embodiments. Alternatively, the task is created when the task management system 130 has received the name of the task and the description of the task.

When maintaining tasks, the task management system 130 maintains a hierarchical data structure of tasks in various embodiments. For example, a task created by the task management system 130 is associated with a list. The list includes one or more tasks having at least one common attribute, allowing organization of related tasks or tasks with one or more common attributes into a list. In various embodiments, the task management system 130 stores an identifier of a list and stores associations between the identifier of the list and identifiers of tasks included in the list to maintain relationships between one or more tasks and a list. Hence, a list includes one or more tasks.

In various embodiments, the task management system 130 leverages the hierarchical relationship between tasks to simplify creation of subtasks for the task by determining 310 a list including the task received 305 from the user. In various embodiments, the task management system 130 determines an identifier of a list associated with the received task to determine 310 the list including the task. Alternatively, the user specifies the list including the task in the information the task management system 130 receives 305 for the task, and the task management system 130 determines 310 the list including the task from the received data for the task.

In various embodiments, the task management system 130 selects 315 a set of supplemental tasks based on the determined list. For example, the task management system 130 selects 315 tasks associated with the determined list that have one or more specific attributes as the supplemental tasks. In an example, the task management system 130 selects 315 tasks associated with the determined list and that were and created by the user as the set of supplemental tasks. In various embodiments, the task management system 130 accounts for times when tasks were created when selecting 315 the set of supplemental tasks. For example, the task management system 130 selects 315 tasks created by the user, associated with the determined list, and created within a threshold amount of time from a time when the task management system 130 received 305 the task from the user for the set of supplemental tasks. As another example, the task management system 130 identifies additional tasks associated with the determined list that were created by the user and generates a ranking of the additional tasks based on times when the additional tasks were created relative to a time when the task management system 130 received 305 the task. For example, additional tasks more recently created by the user have higher positions in the ranking than additional tasks less recently created by the user. The task management system 130 selects 315 additional tasks having at least a threshold position in the ranking as the set of supplemental tasks.

Further, the task management system 130 may account for measures of similarity between the task and additional tasks when selecting 315 the set of supplemental tasks. In various embodiments, the task management system 130 generates an embedding for the task based on received information from the user describing the task. For example, the task management system 130 generates the embedding based on a name of the task and a description of the task received 305 from the user. The task management system 130 also determines embeddings for additional tasks maintained by the task management 130 based on their corresponding names and descriptions. The task management system 130 determines measures of similarity (e.g. a dot product, a cosine similarity, etc.) between the embedding for the task and embeddings for additional tasks maintained by the task management system 130. In some embodiments, the task management system 130 selects 315 the set of supplemental tasks as additional tasks having at least a threshold measure of similarity to the task. Alternatively, the task management system 130 ranks the additional tasks based on their measures of similarity to the task and selects 315 the set of supplemental tasks as additional tasks having at least a threshold position in the ranking. In some embodiments, the additional tasks comprise tasks previously created by the user. Further, in some embodiments, the additional tasks comprise tasks previously created by the user and associated with the determined list. As a further example, the additional tasks comprise tasks created by the user, associated with the determined list, and created within a threshold amount of time of a time when the task management system 130 received 305 the task, or the additional tasks comprise tasks created by the user within a threshold amount of time of the time when the task management system 130 received 305 the task. Different or additional attributes of tasks may be used by the task management system 130 to identify additional tasks in various embodiments.

However, in other embodiments, the task management system 130 selects 315 a supplemental task so each supplemental task has one or more specific attributes, independent of the list including the task. For example, the task management system 130 selects 315 supplemental tasks having embeddings with at least at threshold measure of similarity to the task. In other examples, the task management system 130 selects 315 supplemental tasks associated with the user and having a creation date satisfying one or more criteria (e.g., a creation date within a threshold amount of time from a time when the task management system 130 received 305 the task).

Based on the task and the supplemental tasks of the set, the task management system 130 generates 320 a prompt. In various embodiments, the prompt includes the task and each of the supplemental tasks of the set. For example, the prompt includes a text name of the task, a text description of the task, and text names and text descriptions for each supplemental task of the set. Further, for one or more supplemental tasks associated with subtasks, the prompt includes text describing subtasks associated with the one or more supplemental tasks. Text describing a subtask associated with a supplemental task may include a name of a subtask previously created for a supplemental task or a description of the subtask previously created for the supplemental task. Additionally, the task management system 130 includes one or more comments about a supplemental task stored by the task management system 130 in the prompt. Including subtasks associated with a supplemental task or comments about a supplemental task allows the prompt to provide additional information about formatting or content preferences of the user. Further, one or more comments about the task stored by the task management system 130 may be included in the prompt in various embodiments. The prompt also includes an instruction to generate one or more subtasks for the task. Including the supplemental tasks in the prompt provides information about formatting and content of subtasks based on content and formatting of tasks previously created by the user. Hence, the supplemental tasks included in the prompt provide examples of expected output in response to the text input included in the prompt, allowing the prompt to leverage tasks previously created by the user to specify a format or content of text generated based on the description of the task and the name of the task.

The task management system 130 generates 325 candidate subtasks for the task by applying a generative model to the prompt. In various embodiments, the generative model is a large language model (LLM), such as a generative pre-trained transformer model (GPT). The generative model generates text in response to the text included in the prompt in various embodiments. The generative model is pre-trained through application to a text corpus including text to learn relationships between different portions of text (e.g., words, phrases). The generative model leverages the learned relationships to generate text output in response to a received text prompt. Obtaining a pre-trained generative model allows the task management system 130 to leverage relationships between different portions of text learned by the generative model learned through application to a text corpus including a larger amount of data and more varied data than maintained by the task management system 130 during a pre-training process. In various embodiments, the generative model generates 325 titles or names comprising various candidate subtasks.

The task management system 130 presents 330 the candidate subtasks generated by the generative model to the user. In various embodiments, the generative model generates 325 a group of candidate subtasks based on the generated prompt and the task management system 130 displays each candidate subtask to the user through a subtask interface or another interface. For example, the task management system 130 displays 330 a title of each candidate subtask in an interface. The task management system 130 presents 330 multiple candidate subtasks to the user in some embodiments, while in other embodiments the task management system 130 presents 330 individual candidate subtasks to the user for review one at a time. In some embodiments, the task management system 130 presents 330 candidate subtasks in an order, such as an order in which the generative model generated 325 the candidate subtasks based on the prompt.

In various embodiments, the task management system 130 receives modifications to one or more candidate subtasks from the user. For example, the user interacts with an interface presenting 330 the candidate subtasks to edit a candidate subtask. Example modifications to a subtask include: adding text to a candidate subtask, removing text from a candidate subtask, deleting a candidate subtask, or other types of modifications. The Modifications may be received through the interface or through other inputs in various embodiments. In various embodiments, the user selects a candidate subtask for modifying then provides one or more inputs to the task management system 130 to modify the selected candidate subtask. The task management system 130 stores the modified candidate subtask, allowing the user to subsequently refine one or more of the candidate subtasks generated 325 by the generative model.

The task management system 130 stores 335 one or more of the candidate subtasks in association with the task. For example, the task management system 130 receives a selection of one or more of the candidate subtasks (or of candidate subtasks modified by the user) and stores the selected candidate subtasks in association with the task. Candidate subtasks not selected by the user are not stored in association with the task in various embodiments. In some embodiments, the user assigns a performing user to a candidate subtask in an input to the task management system 130 to store 335 the candidate subtask in association with the task. Alternatively, the user provides additional input to the task management system 130 after an input to store 335 a candidate subtask in association with the task to assign a performing user to the stored candidate subtask or to modify one or more attributes of the stored candidate subtask.

FIG. 4 is a process flow diagram of a method for generating one or more subtasks for a task received from a user using a generative model and supplemental tasks previously created by the user. As further described above in conjunction with FIGS. 2 and 3, a task management system 130 receives one or more tasks from a user. The task management system 130 stores a task in association with a user from whom the task was received and in association with one or more attributes. A task corresponds to an action to be performed, and the task management system 130 receives an identifier of a performing user to perform the action from the user. The task management system 130 maintains one or more attributes of the task providing information about the task, such as a status of the action corresponding to the task by the performing user.

In various embodiments, the task management system 130 receives a task 400 from a user by receiving a name 405 of the task 400 and a description 410 of the task 400. The task 400 is created when the task management system 130 receives the name 405 of the task 400 or the description 410 of the task. In various embodiments, the name 405 of the task 400 comprises unstructured text that the user provides to an interface generated by the task management system 130. Similarly, in various embodiments, the description 410 of the task comprises unstructured text the task management system 130 receives from the user through the interface, or through another interface. The task management system 130 stores a task identifier in association with the name 405 of the task 400 and the description 410 of the task 405 to uniquely identify the task 400, and stores an association between the task identifier and the user to identify the user creating the task 400 (i.e., the user from whom the task 400 was received).

One or more tasks received from the user may be complex involving multiple sub-actions to complete. A complex task may be decomposed into multiple subtasks, with each subtask corresponding to a sub-action to perform in furtherance of completing the action corresponding to the task. Further, different performing users may be assigned to different sub-tasks to further aid in completing the action corresponding to the task. In conventional task management systems, the user manually identifies and describes different subtasks associated with a task. Manually identifying subtasks for a task is often time consuming and requires significant user interaction with the task management system 130 to identify and to modify subtasks based on task. In the example of FIG. 4, task 400 is a complex task, as its description 410 includes descriptive information that describes multiple sub-actions to be completed for completing the task 400.

To more efficiently decompose the task 400 into subtasks, the task management system 130 selects a set 415 of supplemental tasks associated with the task 400. Each supplemental task has one or more specific attributes. For example, each supplemental task was previously created by the user or was previously created by the user and has a creation time satisfying one or more criteria. As further described above in conjunction with FIG. 3, in various embodiments, the task management system 130 maintains a hierarchy of tasks, where a list is associated with one or more tasks, such as one or more tasks having a common attribute. This allows the task management system 130 to organize related tasks into a list, which the task management system 130 leverages to select the set 415 of supplemental tasks in various embodiments. As further described above in conjunction with FIG. 3, in various embodiments, the task management system 130 leverages the hierarchy of tasks to select the set 415 of supplemental tasks. For example, the task management system 130 determines a list including the task and selects tasks previously created by the user and included in the determined list as the set 415 of supplemental tasks.

The task management system 130 may use additional or alternative attributes of tasks created by the user, or otherwise associated with the user, to select the set 415 of supplemental tasks, as further described above in conjunction with FIG. 3. For example, the task management system 130 accounts for times when tasks were created when selecting the set 415 of supplemental tasks. As an example, the task management system 130 selects tasks created by the user, associated with a list associated with the task 400, and created within a threshold amount of time from a time when the task management system 130 received the task 400 from the user as the set 415 of supplemental tasks. In another example, the task management system 130 identifies additional tasks associated with the list associated with the task 400 and that were created by the user. The task management system 130 generates a ranking of the additional tasks based on times when the additional tasks were created relative to a time when the task management system 130 received the task 400. Additional tasks more recently created by the user have higher positions in the ranking than additional tasks less recently created by the user. The task management system 130 selects additional tasks having at least a threshold position in the ranking as the set 415 of supplemental tasks, biasing the set 415 of supplemental tasks to include tasks more recently created by the user.

Based on the task 400 and the set 415 of supplemental tasks, the task management system 130 generates a prompt 420 for a generative model 425, such as a large language model (LLM). The prompt 420 includes the title 405 and the description 410 of the task 400, titles and descriptions of each supplemental task of the set 415, and an instruction to generate one or more subtasks for the task 400 based on the title 405 and the description 410 of the task 400. In various embodiments, the prompt 420 includes descriptive information of one or more subtasks associated with one or more supplemental task of the set 415. For example, a supplemental task of the set 415 is associated with one or more subtasks, so the prompt 420 includes descriptive information of each of the subtasks (e.g., a title of a subtask) associated with the supplemental example. Including the set 415 of supplemental examples in the prompt 420 provides the generative model 425 with examples of an expected output of the generative model 425, allowing the generative model 425 to account for grammatical, stylistic, or other preferences of the user when generating output. This allows the generative model 425 to leverage information about prior task creation by the user through the set 415 of supplemental examples to generate output more accurately reflecting how the user would likely to create subtasks. As further described above in conjunction with FIG. 3, in various embodiments, the prompt 420 includes one or more comments about a supplemental task stored by the task management system 130 in conjunction with the supplemental task or includes one or more comments about the task stored by the task management system 130 may be included in the prompt in various embodiments.

Based on the prompt 420 and previously learned relationships between portions of text during a pre-training process, the generative model 425 generates one or more candidate subtasks 430A–E (also referred to individually and collectively using reference number 430) associated with the task 400. The task management system 130 presents the candidate subtasks 430A–E to the user through an interface or through another communication channel. For example, the task management system 130 displays a title of each candidate subtask 430A–E to the user in a portion of an interface. Subsequently, the user may select one or more of the candidate subtasks 430 to associate with the task 400. The task management system 130 stores the selected candidate subtasks 430 in association with the task 400, but does not store candidate subtasks 430 that are not selected in association with the task 400. For example, the user selects candidate subtask 430B and candidate subtask 430E, but does not select candidate subtask 430A, candidate subtask 430C, or candidate subtask 430D; hence, the task management system 130 stores candidate subtask 430A and candidate subtask 430E in association with task 400, but does not store candidate subtask 430A, candidate subtask 430C, or candidate subtask 430D. As further described above in conjunction with FIG. 3, the user may modify a candidate subtask 430 through one or more interactions with the task management system 130, which stores the modified candidate subtask 430 in response to receiving a specific selection or input from the user. For example, the user adds or modifies one or more words comprising a title of a candidate subtask 430 and provides an input to the task management system 130 to store the modified candidate subtask 430 in association with the task 400.

Leveraging the generative model 425 and the set 415 of supplemental tasks streamlines generation of subtasks that are associated with the task 400. Automatically presenting the candidate subtasks 430 generated by the generative model 425 reduces an amount of time spent by the user decomposing the task 400 into different subtasks, while increasing standardization of form and content of subtasks by using the set 415 of supplemental tasks to account for prior creation of tasks or subtasks by the user. This allows the task management system 130 to more efficiently decompose a task into constituent subtasks, which reduces overall user interaction with the task management system 130.

### Additional Considerations

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a task management system comprising a processor and a non-transitory computer readable medium, comprising:receiving, at the task management system, a task from a user, the task specifying an action for performance by a performing user;determining, by the task management system, a list including the task;selecting, at the task management system, a set of supplemental tasks based on the list including the task, based on creation dates of tasks associated with the list,and based on measures of similarity between an embedding determined for the task and embeddings determined for tasks associated with the list;
generating, by the task management system, a prompt for a generative model including the task and each supplemental task of the set, the prompt including at least a title of the task and a title of each supplemental task of the set;
generating one or more candidate subtasks for the task by applying the generative model to the prompt; presenting the one or more candidate subtasks generated based on the task and each supplemental task of the set to the user through an interface generated by the task management system;
receiving a selection of a candidate subtask from the user via the interface; and
storing the selected candidate subtask in association with the task at the task management system.

2. The method of claim 1, wherein selecting, at the task management system, the set of supplemental tasks based on the list including the task, based on creation dates of tasks associated with the list, and based on measures of similarity between an embedding determined for the task and embeddings determined for tasks associated with the list comprises:
selecting tasks associated with the list including the task and created by the user as the set of supplemental tasks.

3. The method of claim 1, wherein selecting, at the task management system, the set of supplemental tasks based on the list including the task, based on creation dates of tasks associated with the list, and based on measures of similarity between an embedding determined for the task and embeddings determined for tasks associated with the list comprises:selecting tasks associated with the list including the task, created by the user, andcreated within a threshold amount of time from a time when the task management system received the task from the user as the set of supplemental tasks.

4. The method of claim 1, wherein selecting, at the task management system, the set of supplemental tasks based on the list including the task, based on creation dates of tasks associated with the list, and based on measures of similarity between an embedding determined for the task and embeddings determined for tasks associated with the list comprises:selecting additional tasks associated with the list including the task and created by the user;generating a ranking of the additional tasks based on times when the additional tasks were created relative to a time when the task management system received the task from the user, where additional tasks more recently created relative to the time when the task management system received the task have higher positions in the ranking; andselecting additional tasks having at least a threshold position in the ranking as the set of supplemental tasks.

5. The method of claim 1, wherein selecting, at the task management system, the set of supplemental tasks based on the list including the task, based on creation dates of tasks associated with the list, and based on measures of similarity between an embedding determined for the task and embeddings determined for tasks associated with the list comprises:generating the embedding for the task based on received information from the user describing the task;determining embeddings for additional tasks maintained by the task management system; andselecting additional tasks having embeddings with at least a threshold measure of similarity to the embedding for the task as the set of supplemental tasks.

6. The method of claim 5, wherein each additional task was created by the user.

7. The method of claim 6, wherein each additional task is associated with the list including the task.

8. The method of claim 7, wherein each additional task was created within a threshold amount of time of a time when the task management system received the task.

9. The method of claim 5, wherein the embedding for the task is determined based on a name of the task and a description of the task.

10. The method of claim 1, further comprising:modifying the selected candidate subtask in response to the task management system receiving an input from the user.

11. A computer program product comprising a non-transitory computer readable storage medium having instructions encoded thereon that, when executed by a processor, cause the processor to perform steps comprising:receiving, at a task management system including the processor, a task from a user,the task specifying an action for performance by a performing user;determining, by the task management system, a list including the task;selecting, at the task management system, a set of supplemental tasks based on the list including the task;generating, by the task management system, a prompt for a generative model including the task and each supplemental task of the set, the prompt including at least a title of the task and a title of each supplemental task of the set;generating one or more candidate subtasks for the task by applying the generative model to the prompt; presenting the one or more candidate subtasks generated based on the task and each supplemental task of the set to the user through an interface generated by the task management system;receiving a selection of a candidate subtask from the user via the interface; andstoring the selected candidate subtask in association with the task at the task management system.

12. The computer program product of claim 11, wherein selecting, at the task management system, the set of supplemental tasks based on the list including the task, based on creation dates of tasks associated with the list, and based on measures of similarity between an embedding determined for the task and embeddings determined for tasks associated with the list comprises:selecting tasks associated with the list including the task and created by the user as the set of supplemental tasks.

13. The computer program product of claim 11, wherein selecting, at the task management system, the set of supplemental tasks based on the list including the task, based on creation dates of tasks associated with the list, and based on measures of similarity between an embedding determined for the task and embeddings determined for tasks associated with the list comprises:selecting tasks associated with the list including the task, created by the user, andcreated within a threshold amount of time from a time when the task management system received the task from the user as the set of supplemental tasks.

14. The computer program product of claim 11, wherein selecting, at the task management system, the set of supplemental tasks based on the list including the task, based on creation dates of tasks associated with the list, and based on measures of similarity between an embedding determined for the task and embeddings determined for tasks associated with the list comprises:selecting additional tasks associated with the list including the task and created by the user;generating a ranking of the additional tasks based on times when the additional tasks were created relative to a time when the task management system received the task from the user, where additional tasks more recently created relative to the time when the task management system received the task have higher positions in the ranking; andselecting additional tasks having at least a threshold position in the ranking as the set of supplemental tasks.

15. The computer program product of claim 11, wherein selecting, at the task management system, the set of supplemental tasks based on the list including the task, based on creation dates of tasks associated with the list, and based on
measures of similarity between an embedding determined for the task and embeddings determined for tasks associated with the list comprises:generating an embedding for the task based on received information from the user describing the task;determining embeddings for additional tasks maintained by the task management system; andselecting additional tasks having embeddings with at least a threshold measure of similarity to the embedding for the task as the set of supplemental tasks.

16. The computer program product of claim 15, wherein each additional task was created by the user.

17. The computer program product of claim 16, wherein each additional task is associated with the list including the task.

18. The computer program product of claim 17, wherein each additional task was created within a threshold amount of time of a time when the task management system received the task.

19. The computer program product of claim 11, wherein the non-transitory computer readable storage medium further has instructions encoded thereon, that, when executed by the processor, cause the processor to perform steps comprising:modifying the selected candidate subtask in response to the task management system receiving an input from the user.

20. A method performed at a task management system comprising a processor and a non-transitory computer readable medium, comprising:
receiving, at the task management system, a task from a user, the task specifying an action for performance by a performing user;
selecting, at the task management system, a set of supplemental tasks that each have one or more specific attributes based on creation dates of the task and of tasks stored by the task management system and based on measures of similarity between an embedding determined for the task and embeddings determined for tasks maintained by the task management system;
generating, by the task management system, a prompt for a generative model including the task and each supplemental task of the set, the prompt including at least a title of the task and a title of each supplemental task of the set;
generating one or more candidate subtasks for the task by applying the generative model to the prompt; presenting the one or more candidate subtasks generated based on the task and each supplemental task of the set to the user through an interface generated by the task management system;
receiving a selection of a candidate subtask from the user via the interface; and storing the selected candidate subtask in association with the task at the task management system.
